(19) United States
(12) Patent Application Publication
(10) Pub. No.: US 2009/0085324 A1
(43) Pub. Date: Apr. 2, 2009

(54) DUAL-TRACK TILT MECHANISM

(76) Inventors: Corey Blauch, Dunmore, PA (US); James Patrick Mulhern, Nanticoke, PA (US)

Correspondence Address: WOODCOCK WASHBURN, LLP, CIRA CENTRE, 12TH FLOOR, 2929 ARCH STREET, PHILADELPHIA, PA, 19104-2891, US

(21) Appl. No.: 12/243,606

(22) Filed: Oct. 1, 2008

Related U.S. Application Data
(60) Provisional application No. 60/976,751, filed on Oct. 1, 2007.

(51) Int. Cl. A61G 5/10

(52) U.S. Cl. 280/304.1

(57) ABSTRACT

The present invention is directed to a tilt-in-space wheelchair that limits the shift of the center of a gravity of a wheelchair occupant during tilting. The wheelchair comprises a main frame adapted to be supported on a surface by wheels, a seat frame for supporting a occupant, and an arc plate for slidably or rollably supporting the seat frame with respect to the main frame. The arc plate defines a first track and a second track that guide the tilting of the seat frame relative to the frame. The first track and second track may have non-constant curvatures. Further, the first track and second track may be arranged non-concentrically on the arc plate and may have different lengths.

### RELATED APPLICATION

This application claims the benefit of provisional patent application No. 60/976,751, filed Oct. 1, 2007; the entire disclosure of which is incorporated by reference.

### TECHNOLOGY FIELD

The present invention is generally directed to a wheelchair. More particularly, the present invention is directed to a tilt-in-space wheelchair.

### BACKGROUND

The pressure from sitting in a single position for an extended period of time cuts off circulation to vulnerable parts of the body. As a result, patients who are bound to a wheelchair for extended periods of time may develop pressure sores or pressure ulcers. Tilt-in-space wheelchairs have been developed to transfer pressure from the seat surface to the back surface by tilting or reclining a seated patient. While conventional tilt-in-space wheelchairs are effective at shifting weight and pressure for patients who cannot otherwise do so, they are deficient in other ways. For example, some tilt-in-space wheelchairs may cause sudden shifts in the center of gravity of a seated patient. A sudden shift in the center of gravity of a patient may produce a falling sensation and a startle reflex as a result. Startle reflex may cause hypertonia in some patients, which is characterized by increased tightness of muscle tone that may lead to loss of function and deformity.

U.S. Pat. No. 7,007,965 is directed to a tilt-in-space wheelchair having a seat supported relative to a base by a rocker that has a constant curvature and is designed to maintain the center of gravity of a wheelchair occupant at a fixed location during tilting. In order for the center of gravity of the wheelchair occupant to remain at a fixed location during tilting, however, the focal point of the curve of the rocker must coincide with the center of gravity of the wheelchair occupant. Because different wheelchair occupants may have different centers of gravity that may not be easily determined, the wheelchair may need significant adjustments to ensure that the the focal point of the curve of the rocker coincides with the center of gravity of the wheelchair occupant.

### SUMMARY

This Summary is provided to introduce a selection of concepts in a simplified form that are further described below in the Detailed Description of Illustrative Embodiments. This Summary is not intended to identify key features or essential features of the invention, nor is it intended to be used to limit the scope of the invention.

The present invention is directed to a tilt-in-space wheelchair that limits the shift of the center of a gravity of a wheelchair occupant during tilting. The wheelchair comprises a main frame adapted to be supported on a surface by wheels, a seat frame for supporting a occupant, and an arc plate for slidably or rollably supporting the seat frame with respect to the main frame. The arc plate defines a first track and a second track that guide the tilting of the seat frame relative to the frame. According to one embodiment, the first track and second track have non-constant curvatures. Further, the first track and second track may be arranged non-concentrically on the arc plate and may have different lengths. According to another embodiment, the first track and second track preferably have constant curvatures and are arranged non-concentrically on the arc plate. Further, the constant curvatures of the first track and second track may be different and the lengths of the first track and second track may also be different.

According to another aspect of the invention, the arc plate may be connected to the seat frame and the first track and second track rest on rollers or slides that are disposed on a support plate connected to the main frame. Thus, the seat frame and arc plate may move relative to the main frame. In another embodiment, the arc plate is connected to the main frame and the seat frame is connected to a support plate having rollers or slides that engage the first track and second track of the arc plate. Thus, the seat frame may move relative to the arc plate connected to the main frame.

Additional features and advantages will be made apparent from the following detailed description of illustrative embodiments that proceeds with reference to the accompanying drawings.

### BRIEF DESCRIPTION OF THE DRAWINGS

The foregoing summary, as well as the following detailed description, is better understood when read in conjunction with the appended drawings. For the purpose of illustrating the reconstruction device and related method thereof, there is shown in the drawings exemplary embodiments; however, the wheelchair is not limited to the specific embodiments disclosed.

FIG. 1 shows an perspective view of an exemplary dual-track, tilt-in-space wheelchair with portions of the wheelchair removed for clarity;

FIG. 2A shows a right side view of the wheelchair shown in FIG. 1;

FIG. 2B shows a left side view of the wheelchair shown in FIG. 1;

FIG. 3A shows a right side view of an exemplary seat frame supported on an exemplary main frame by an exemplary arc plate;

FIG. 3B shows a left side view of the seat frame, main frame, and arc plate shown in FIG. 3A; and

FIG. 4 shows a side view of another exemplary arc plate.

### DETAILED DESCRIPTION OF ILLUSTRATIVE EMBODIMENTS

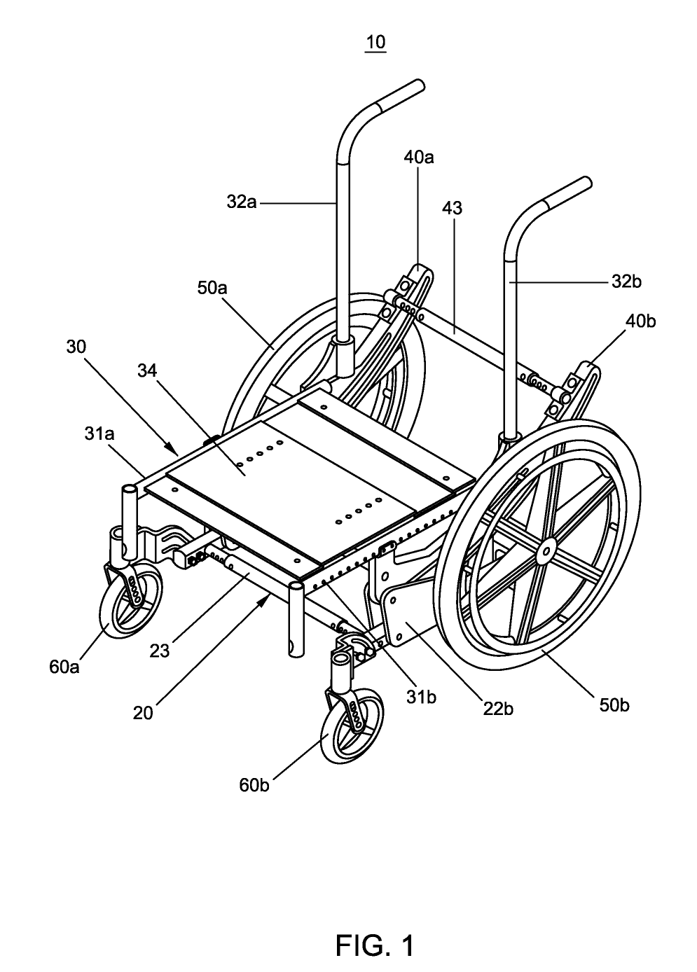

A dual-track, tilt-in-space wheelchair 10 allows tilting of an occupant while limiting shifting of the center of gravity of the occupant. As shown in FIG. 1, the wheelchair 10 may comprise a main frame 20, a seat frame 30, arc plates 40a, 40b, wheels 50a, 50b, and caster wheels 60a, 60b. The main frame 20 is supported on a surface by wheels 50a, 50b, and caster wheels 60a, 60b. The seat frame 30 is supported on the main frame 20 by arc plates 40a, 40b such that the seat frame 30 may be tilted relative to the main frame 20. Thus, an occupant supported by the seat frame 30 may be reclined by tilting the seat frame 30 relative to the main frame 20.

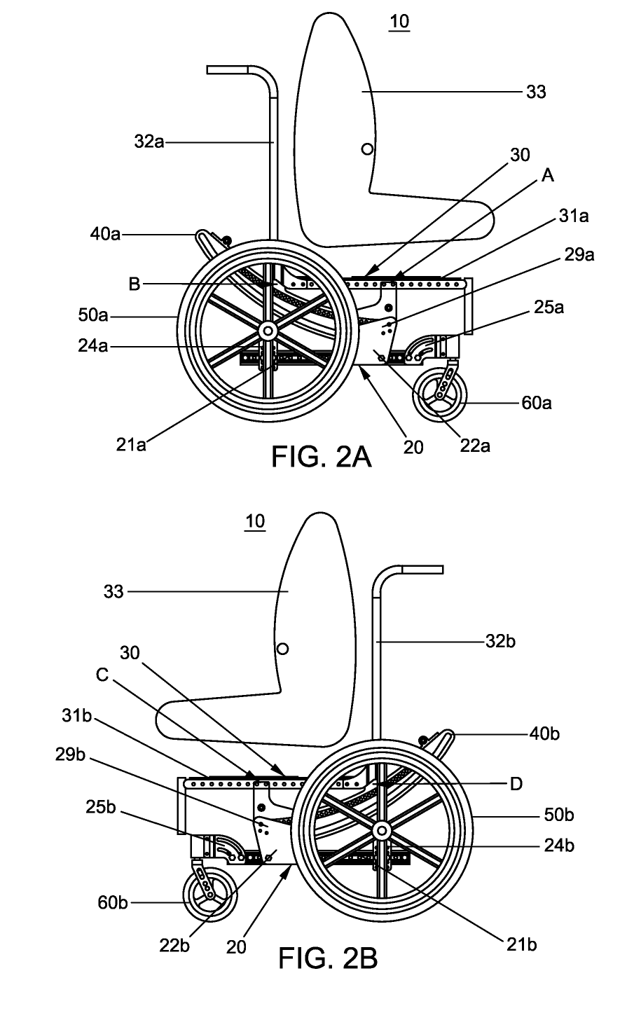

As shown in the embodiment of FIGS. 1-2B, the main frame 20 may comprise side, main-frame tubes 21a, 21b, support plates 22a, 22b, rollers or slides 28a, 29a, 28b, 29b, axle plates 24a, 24b, and caster plates 25a, 25b. As shown, the side, main-frame tubes 21a, 21b are preferably disposed horizontally, parallel to the forward and rearward directions of travel of the wheelchair 10. Also, the side, main-frame tubes 21a, 21b each preferably have a series of holes 26a, 26b that are disposed along their longitudinal axis so that plates may be attached at different locations along their lengths. The support plates 22a, 22b, axle plates 24a, 24b, and caster plates 25a, 25b each have holes 27a, 27b that are adpated to be aligned with the holes 26a, 26b of the side, main-frame tubes 21a, 21b so that the plates may be fastened to the side, main-frame tubes 21a, 21b.

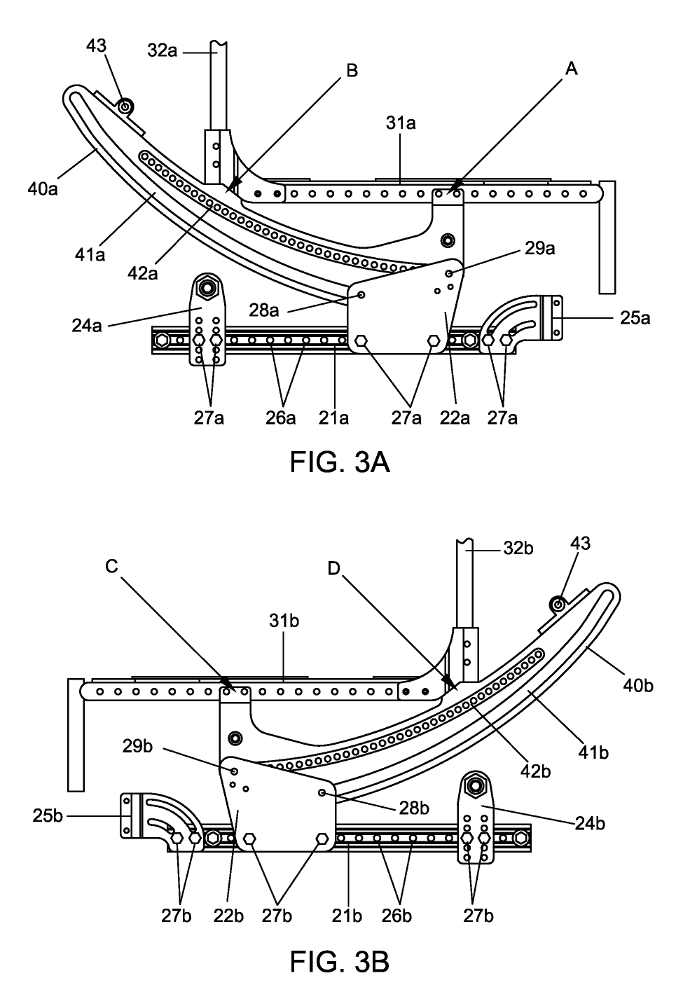

As shown in FIG. 2A and 3A, the right side of the main frame 20 may be assembled by connecting the support plate 22a, axle plate 24a, and caster plate 25a to the side, main-frame tube 21a. The support plate 22a, axle plate 24a, and caster plate 25a may be connected to the side, main-frame tube 21 a by aligning the holes 27a of each of the plates with different holes 26a along the side, main-frame tube 21a and inserting fasteners through the holes 26a, 27a. Preferably, the axle plate 24a is rearwardly connected to the side, main-frame tube 21a, the caster plate 25a is forwardly connected to the side, main-frame tube 21a, and the support plate 22a is centrally connected to the side, main-frame tube 21 a. Similarly, the left side of the main frame 20 may be assembled to mirror the right side. As shown in FIG. 2B and 3B, the support plate 22b, axle plate 24b, and caster plate 25b are connected to the side, main-frame tube 21b. The support plate 22b, axle plate 24b, and caster plate 25b may be connected to the side, main-frame tube 21b by aligning the holes 27b of each of the plates with different holes 26b along the side, main-frame tube 21b and inserting fasteners through the holes 26b, 27b. Preferably, the axle plate 24b is rearwardly connected to the side, main-frame tube 21b, the caster plate 25b is forwardly connected to the side, main-frame tube 21b, and the support plate 22b is centrally connected to the side, main-frame tube 21b. The right and left sides of the main frame 20 may be spaced apart opposite and parallel to each other so that the right side mirrors the left side. Further, as shown in FIG. 1, the right and left sides of the main frame 20 are preferably connected to each other by one or more cross, main-frame tubes 23 that are attached transversely to the side, main-frame tubes 21a, 21b.

As shown in FIGS. 2A-2B, wheels 50a, 50b may be mounted on the axle plates 24a, 24b and caster wheels 60a, 60b may be mounted on the caster plates 25a, 25b. Thus, the main frame 20 can be supported and rolled on a generally planar surface by the wheels 50a, 50b and caster wheels 60a, 60b. As shown, the wheels 50a, 50b are preferably mounted rearward on the main frame 20 and the caster wheels 60a, 60b are preferably mounted forward on the main frame 20.

According to the embodiment of FIGS. 2A-2B, the seat frame 30 comprises side, seat-frame tubes 31a, 31b, back canes 32a, 32b, and a seat 33. The side, seat-frame tubes 31a, 31b are preferably disposed horizontally, parallel to the forward and rearward directions of travel of the wheelchair 10. The right side of the seat frame 30 includes a side, seat-frame tube 31a and a back cane 32a extending upwardly from the rear of the side, seat-frame tube 31a. The left side of the seat frame 30 includes a side, seat-frame tube 31b and a back cane 32b extending upwardly from the rear of the side, seat-frame tube 31b. The right and left sides of the seat frame 30 may be spaced apart opposite and parallel to each other so that the right side mirrors the left side. Further, as shown in FIG. 1, the right and left sides of the seat frame 30 are preferably connected to each other by a plate 34 attached transversely to the side, seat-frame tubes 3la, 31b. The seat 30 may be attached to the side, seat-frame tubes 3la, 31b, back canes 32a, 32b, and/or plate 34 to support an occupant on the wheelchair 10.

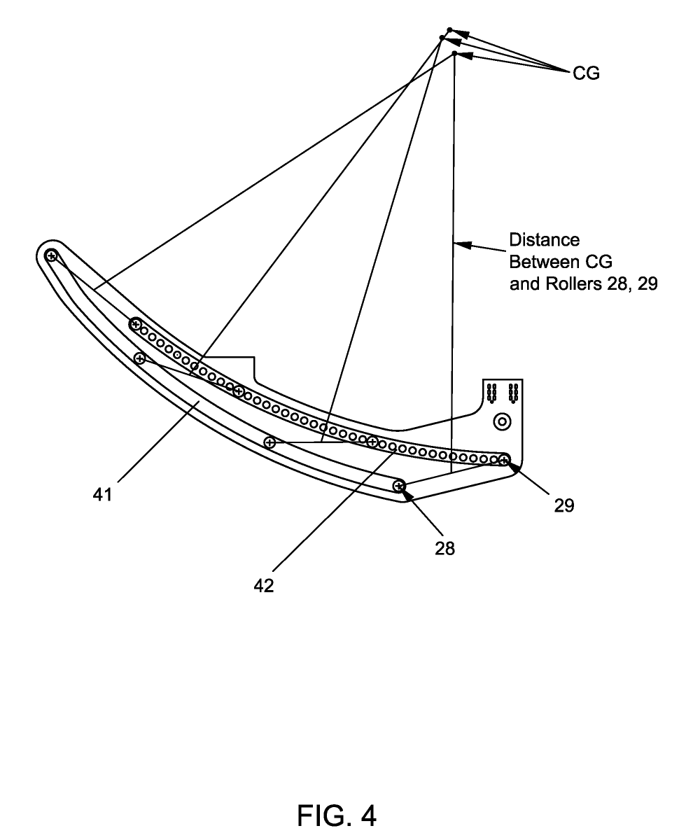

The seat frame 30 is slidably supported relative to the main frame 20 by at least one arc plate 40. Reference numeral 40 refers generally to an arc plate, and reference numerals 40a and 40b refer more specifically to a right arc plate 40a and a left arc plate 40b. As shown, the same reference numerals refer to the same elements and letters a and b designate whether the element corresponds to the right arc plate 40a or left arc plate 40b, respectively. Although seat frame 30 is shown supported relative to the main frame by two arc plates 40a, 40b, the design of the present invention may be modified to include only one arc plate or more than two arc plates having the same structure as arc plate 40 located anywhere on the wheel chair, without deviating from the objective of the present invention. As shown in FIGS. 4, each arc plate 40 defines a first track 41 and a second track 42. Although the present invention is herein described as comprising a first track 41 and a second track 42, it is understood by those skilled in the art that the present invention may instead be adapted to incorporate a first rail and a second rail without deviating from the objective of the present invention.

According to the embodiment shown in FIGS. 3A-4, the first 41 and second 42 tracks preferably have non-constant curvatures, and more preferably, have curvatures comprising at least two radii of curvature. As shown, the first 41 and second 42 tracks preferably are positioned non-concentrically with respect to each other. In other words, the focal point of a portion of the first track 41 does not coincide with the focal point of a corresponding portion of the second track 42. Thus, the first 41 and second 42 tracks may be arranged so that the spacing between them varies along their lengths. Additionally, although not necessary, the first 41 and second 42 tracks preferably have the same curvature and overall length. According to another embodiment (not shown), the first 41 and second 42 tracks preferably have a constant curvature and are arranged non-concentrically with respect to each other so that the focal point of the first track 41 does not coincide with the focal point of the second track 42. Thus, the first 41 and second 42 tracks may be arranged so that the spacing between them varies along their lengths. Additionally, although not necessary, the first 41 and second 42 tracks preferably have the same curvature and overall length.

According to the embodiment shown in FIGS. 2A-3B, the right side of the seat frame 30 may be supported relative to the right side of the main frame 20 by arc plate 40a. As shown, arc plate 40a is attached to the side, seat-frame tube 31 a at points A and B, which can be accomplished by any conventional means, such as welding, fastening, etc. The first 41 a and second 42a tracks of the arc plate 40a slidably or rollably engage the support plate 22a. Preferably, as shown in FIG. 3A, the support plate 22a has two rollers or sliders 28a, 29a that are spaced apart and adapted to engage the first 41 a and second 42a tracks of the arc plate 40a, respectively. The two rollers or sliders 28a, 29a are spaced apart to prevent binding of the first 41 a and second 42a tracks as the arc plate 40a moves relative to the main frame 20. Similarly, the left side of the seat frame 30 may be connected and supported relative to the left side of the main frame 20 by arc plate 40b. As shown, arc plate 40b is attached to the side, seat-frame tube 31b at points C and D, which can be accomplished by any conventional means, such as welding, fastening, etc. The first 41b and second 42b tracks of the arc plate 40b slidably or rollably engage the support plate 22b. Preferably, as shown in FIG. 3B, the support plate 22b has two rollers or sliders 28b, 29b that are spaced apart and adapted to engage the first 41band second 42b tracks of the arc plate 40b, respectively. The two rollers or sliders 28b, 29b are spaced apart to prevent binding of the the first 41 b and second 42b tracks as the arc plate 40b moves relative to the main frame 20. As shown in FIG. 1, the arc plates 40a, 40b are disposed opposite and parallel to each other and are connected by a cross tube 43.

Thus, the seat frame 30 is attached to the arc plates 40a, 40b and is designed to tilt by allowing the first 41a, 41b and second 42a, 42b tracks of the arc plates 40a, 40b to slide along the rollers or sliders 28a, 29a, 28b, 29b disposed on the support plates 22a, 22b of the main frame 20. The structure and arrangement of the first 41a, 41b and second 42a, 42b tracks in accordance with the present invention provide at least two advantages. First, a predetermined amount of tilt may be achieved with shorter tracks than would be possible with conventional track structures and arrangements. This allows for a more compact wheelchair design. Second, the structure and arrangement of the first 41a, 41b and second 42a, 42b tracks may be adjusted to limit the shift of an occupant's center of gravity during tilting of the seat 33. This allows for a wheelchair design that limits the possibility of startle reflex during tilting for a variety of occupants having different centers of gravity. These advantages are not intended to be limiting.

The first 41 and second 42 tracks are preferably positioned non-concentrically so that the spacing between them varies along their lengths. For example, the spacing between tracks 41 and 42 at any point may be measured normal from a tangent at either track. The tilt of the seat frame 30 relative to the main frame 20 is caused by the fact that the spacing between the rollers 28, 29 is fixed and the rollers 28, 29 travel along a first track 41 and a second track 42, respectively, that have varying spacing between them. Additionally, the curvature of the first track 41 and second track 42 may be made different and/or non-constant to produce further tilting of the seat frame 30 relative to the main frame 20. As a result, the curvature and spacing of the first 41 and second 42 tracks may be adjusted to achieve a predetermined amount of tilt over a shorter length of track. Further, the curvature and spacing of the first 41 and second 42 tracks of the arc plate 40 may be adjusted to limit the shifting of the center of gravity of an occupant for a predetermined amount of tilt. FIG. 4 shows one embodiment of an arc plate 40 and the shift of the center of gravity (CG) of an occupant at various degrees of tilt.

Although the arc plate 40 is shown attached to the side, seat-frame tube 31, the design of the present invention may be modified to have the arc plate 40 attached to the side, main-frame tube 21 without deviating from the objective of the present invention. In this embodiment, the support plates 22a, 22b may be attached to the side, seat-frame tubes 31a, 31b so that the rollers or sliders 28a, 29a, 28b, 29b of the support plates 22a, 22b may slide along the first 41a, 41b and second 42a, 42b tracks of the arc plates 40a, 40b attached to the main frame 20. Thus, the seat frame 30 may slide relative to both the arc plates 40a, 40b and main frame 20.

What is claimed:

1. A wheelchair comprising:
a main frame;
a plurality of wheels adapted to support the frame relative to a supporting surface;
a seat frame for supporting an occupant; and
an arc plate adapted to support the seat frame relative to the main frame, the arc plate defining a first track and a second track that serve as rolling or sliding surfaces and allow the seat frame to tilt relative to the main frame, each track having a non-constant curvature.

2. The wheelchair of claim 1, wherein shifting of the center of gravity of the occupant is limited when the seat frame is tilted relative to the main frame.

3. The wheelchair of claim 1, wherein the curvature of the first track and the curvature of the second track are the same.

4. The wheelchair of claim 1, wherein the first track and second track have a curvature comprising two radii of curvature.

5. The wheelchair of claim 1, wherein the length of the first track and the length of the second track are the same.

6. The wheelchair of claim 1, wherein the first track is positioned non-concentrically with respect to the second track.

7. The wheelchair of claim 1, wherein the arc plate is attached to the seat frame.

8. The wheelchair of claim 7, further comprising a support plate attached to the main frame and adapted to slidably or rollably engage the arc plate.

9. The wheelchair of claim 8, further comprising two rollers disposed on the support plate, each roller adapted to engage one of the first track or second track.

10. The wheelchair of claim 1, wherein the arc plate is connected to the main frame.

11. The wheelchair of claim 10, further comprising a support plate connected to the seat frame and adapted to slidably or rollably engage the arc plate.

12. The wheelchair of claim 11, further comprising two rollers disposed on the support plate, each roller adapted to engage one of the first track or second track.

13. A wheelchair comprising:
a main frame;
a plurality of wheels adapted to support the frame relative to a supporting surface;
a seat frame for supporting an occupant; and
an arc plate adapted to support the seat frame relative to the main frame, the arc plate defining a first track and a second track that serve as rolling or sliding surfaces and allow the seat frame to tilt relative to the main frame, the first track and second track spaced apart by a varying dimension along their lengths.

14. The wheelchair of claim 13 further comprising a support plate having a first roller or slide movably engaged with the first track and a second roller or slide movably engaged with the second track.
